(19) United States
(12) Patent Application Publication
(10) Pub. No.: US 2026/0085012 A1
(43) Pub. Date: Mar. 26, 2026

(54) COMPOSITION, SHEET-LIKE PRODUCT, MULTILAYER BODY, METHOD FOR MANUFACTURING COMPOSITION, AND CHIP-TYPE MULTILAYER ELECTRONIC COMPONENT

(71) Applicant: Murata Manufacturing Co., Ltd., Kyoto-fu (JP)

(72) Inventors: Ayumi YAMAMOTO, Nagaokakyo-shi (JP); Reiji OZAWA, Nagaokakyo-shi (JP)

(73) Assignee: Murata Manufacturing Co., Ltd., Kyoto-fu (JP)

(21) Appl. No.: 19/329,019

(22) Filed: Sep. 15, 2025

(30) Foreign Application Priority Data
Sep. 24, 2024 (JP) 2024-165346

(51) Int. Cl. C04B 35/26; B32B 27/20; B32B 27/22; C04B 35/634; C04B 35/64

(52) U.S. Cl. CPC C04B 35/26; B32B 27/20; B32B 27/22; C04B 35/6342; C04B 35/64; B32B 2264/107

(57) ABSTRACT

A composition contains an inorganic powder, a binder resin, and a plasticizer. The plasticizer contains a compound having a structure represented by general formula (1) below

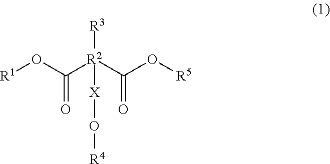

wherein (In general formula (1), R¹ is a C1-C12 hydrocarbon group. In general formula (1), R² is a C1-C12 hydrocarbon group. In general formula (1), R³ is a hydrogen atom, a hydroxy group, a carboxy group, a C2-C12 ester group, a C2-C12 acyl group, a C2-C12 acyloxy group, or a C1-C12 alkoxy group. In general formula (1), X is a single bond or a C1-C12 hydrocarbon group. In general formula (1), R⁴ is a hydrogen atom, a C2-C12 acyl group, or a C1-C12 hydrocarbon group. In general formula (1), R⁵ is a hydrogen atom or a C1-C12 hydrocarbon group).

### CROSS-REFERENCE TO RELATED APPLICATION

This application claims benefit of priority to Japanese Patent Application No. 2024-165346, filed Sep. 24, 2024, the entire content of which is incorporated herein by reference

### BACKGROUND

### Technical Field

The present disclosure relates to a composition, a sheet-like product, a multilayer body, a method for manufacturing the composition, and a chip-type multilayer electronic component.

### Background Art

In general, ceramic green sheets for multilayer ceramic electronic components are produced by forming a slurry containing ceramic particles and a binder resin into a sheet shape. For example, vinyl acetate resin is used as the binder resin.

A plasticizer is added to the slurry to improve formability when forming the slurry into a sheet shape or to improve adhesion when stacking the formed sheet-like products. The addition of the plasticizer lowers the glass transition temperature (Tg) of the binder resin to improve the plasticity of the slurry. Phthalate esters have been used as such plasticizers.

Japanese Unexamined Patent Application Publication No. 2002-179925 discloses a ceramic green sheet containing a ceramic powder, a binder resin, a plasticizer added in an amount exceeding the saturation level for the binder resin, and a solvent, and discloses the use of phthalate esters as plasticizers.

### SUMMARY

In recent years, phthalate esters have been regulated by, for example, the Revised RoHS (RoHS2) Directive due to concerns about their effects on human health. In other words, the ceramic green sheet described in Japanese Unexamined Patent Application Publication No. 2002-179925 has a high environmental impact due to the use of phthalate esters as plasticizers.

The present disclosure aims at providing a composition having plasticity suitable for forming a sheet-like product despite its low environmental impact.

The composition of the present disclosure contains an inorganic powder, a binder resin, and a plasticizer, wherein the plasticizer contains a compound having a structure represented by general formula (1) below:

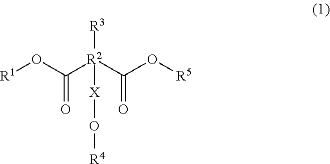

(In general formula (1), R¹ is a C1-C12 hydrocarbon group.

In general formula (1), R² is a C1-C12 hydrocarbon group.

In general formula (1), R³ is a hydrogen atom, a hydroxy group, a carboxy group, a C2-C12 ester group, a C2-C12 acyl group, a C2-C12 acyloxy group, or a C1-C12 alkoxy group.

In general formula (1), X is a single bond or a C1-C12 hydrocarbon group.

In general formula (1), R⁴ is a hydrogen atom, a C2-C12 acyl group, or a C1-C12 hydrocarbon group.

In general formula (1), R⁵ is a hydrogen atom or a C1-C12 hydrocarbon group).

A sheet-like product of the present disclosure contains the composition of the present disclosure.

A multilayer body of the present disclosure includes a plurality of the sheet-like products of the present disclosure stacked on top of one another.

A method for manufacturing a composition of the present disclosure includes a grinding step of grinding an inorganic material into an inorganic powder and a mixing step of mixing the inorganic powder, a binder resin, and a plasticizer, wherein the plasticizer contains a compound having a structure represented by general formula (1) below:

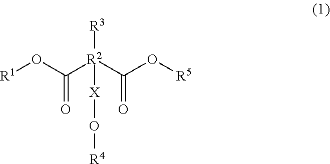

(In general formula (1), R¹ is a C1-C12 hydrocarbon group.

In general formula (1), R² is a C1-C12 hydrocarbon group.

In general formula (1), R³ is a hydrogen atom, a hydroxy group, a carboxy group, a C2-C12 ester group, a C2-C12 acyl group, a C2-C12 acyloxy group, or a C1-C12 alkoxy group.

In general formula (1), X is a single bond or a C1-C12 hydrocarbon group.

In general formula (1), R⁴ is a hydrogen atom, a C2-C12 acyl group, or a C1-C6 hydrocarbon group.

In general formula (1), R⁵ is a hydrogen atom or a C1-C12 hydrocarbon group).

A chip-type multilayer electronic component includes a base body including a plurality of fired sheets stacked on top of one another, wherein the base body has a striped pattern perpendicular to the stacking direction when viewed from the side surface.

The present disclosure can provide a composition having plasticity suitable for forming a sheet-like product despite its low environmental impact.

### BRIEF DESCRIPTION OF THE DRAWINGS

FIG. 1A is a schematic cross-sectional view of an example of a sheet-like product of the present disclosure;

FIG. 1B is an enlarged view of an area enclosed by the dashed line in FIG. 1A;

FIG. 2A is a schematic view of an example of a process for producing a multilayer body using the sheet-like products of the present disclosure;

FIG. 2B is a schematic view of an example of the process for producing a multilayer body using the sheet-like products of the present disclosure; and

FIG. 3 is a schematic side view of an example of a base body including a plurality of fired sheets stacked on top of one another.

### DETAILED DESCRIPTION

The composition, the sheet-like product, the multilayer body, the method for manufacturing the composition, and the chip-type multilayer electronic component of the present disclosure will be described below.

However, the present disclosure is not limited to the following embodiments and can be modified as appropriate and applied without departing from the spirit of the present disclosure. A combination of two or more individual preferred components of the present disclosure described in the following embodiments is also within the present disclosure.

The figures described below illustrate schematic views, and the size, the aspect ratio, and the like are not necessarily drawn to scale.

It should be understood that the embodiments described below are illustrative only, and partial replacements or combinations of the components described in the embodiments are optionally possible.

The composition of the present disclosure contains an inorganic powder, a binder resin, and a plasticizer, wherein the plasticizer contains a compound having a structure represented by general formula (1) below:

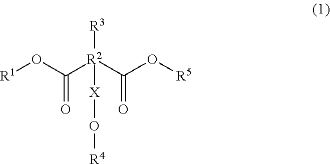

(In general formula (1), R¹ is a C1-C12 hydrocarbon group.

In general formula (1), R² is a C1-C12 hydrocarbon group.

In general formula (1), R³ is a hydrogen atom, a hydroxy group, a carboxy group, a C2-C12 ester group, a C2-C12 acyl group, a C2-C12 acyloxy group, or a C1-C12 alkoxy group.

In general formula (1), X is a single bond or a C1-C12 hydrocarbon group.

In general formula (1), R⁴ is a hydrogen atom, a C2-C12 acyl group, or a C1-C12 hydrocarbon group.

In general formula (1), R⁵ is a hydrogen atom or a C1-C12 hydrocarbon group).

The compound having the structure represented by general formula (1) above is not a phthalate ester. The composition of the present disclosure thus has a low environmental impact.

When R¹, R², R³, R⁴, and R⁵ have the above structure, the compound having the structure represented by general formula (1) is easy to handle because the compound is liquid at room temperature (25° C.).

The plasticizer containing the compound having the structure represented by general formula (1) above can sufficiently improve the plasticity of the composition containing the inorganic powder and the binder resin. Therefore, the composition of the present disclosure can be suitably used to form a sheet-like product.

The principle that enables the plasticity of the composition to be sufficiently improved may be as described below.

A binder resin is typically composed of molecules with polar groups.

The “—R³” or “—X—O—R⁴” (polar group) moiety of the structure represented by general formula (1) above easily orients toward the polar groups of the molecules of the binder resin, so that the plasticizer can easily penetrate the spaces between the molecules of the binder resin. This can block the orientation of the polar groups of the molecules of the binder resin and can thus increase the spaces between the molecular chains of the binder resin to facilitate the movement of the molecular chains.

Furthermore, the structure represented by general formula (1) above has a bulky molecular structure due to the presence of two or more ester groups. This structure can further increase the effect of blocking the orientation of the polar groups of the molecules of the binder resin.

This principle allows the reduction of the Tg of the binder resin, resulting in improved plasticity of the composition.

Each component of the composition of the present disclosure will be described below.

### Inorganic Powder

In the composition of the present disclosure, the inorganic powder may be a ceramic powder. In this case, a ceramic green sheet can be produced by forming the composition of the present disclosure into a sheet-like product.

In the composition of the present disclosure, the inorganic powder preferably contains at least one selected from the group consisting of zirconia, titania, alumina, barium titanate, ferrite, PZT, zinc oxide, glass, and glass ceramics. These materials are suitable for manufacturing the chip-type multilayer electronic component using the composition of the present disclosure.

In the composition of the present disclosure, the inorganic powder preferably, but not necessarily, has an average particle size of 0.01 μm or more and 50 μm or less (i.e., from 0.01 μm to 50 μm).

In the composition of the present disclosure, the percentage of the inorganic powder is preferably 45 vol % or more and 75 vol % or less (i.e., from 45 vol % to 75 vol %), more preferably 55 vol % or more and 70 vol % or less (i.e., from 55 vol % to 70 vol %).

As described below in detail, the composition of the present disclosure is used to produce sheet-like products. The sheet-like products are stacked and sintered to form a base body of the chip-type multilayer electronic component.

When the percentage of the inorganic powder is within the above range, the produced base body has suitable density and strength to function as part of the chip-type multilayer electronic component.

### Binder Resin

In the composition of the present disclosure, the binder resin preferably contains at least one selected from the group consisting of polyvinyl acetate, polyvinyl butyral, polyvinyl alcohol, acrylic, urethane, polyvinyl pyrrolidone, polyethylene glycol, ethylene-vinyl acetate copolymer, and cellulose ether, more preferably contains polyvinyl acetate.

These binder resins can bond the inorganic powder particles together and are thus suitable for forming the composition of the present disclosure into a predetermined shape.

In particular, when the binder resin is polyvinyl acetate, the “—R³” or “—X—O—R⁴” (polar group) moiety of the structure represented by general formula (1) above easily orients toward the acetyloxy groups of polyvinyl acetate molecules, so that the plasticizer can easily penetrate the spaces between polyvinyl acetate molecules. This can block the orientation of the acetyloxy groups of polyvinyl acetate molecules and can thus increase the spaces between the molecular chains of polyvinyl acetate to facilitate the movement of the molecular chains.

For this, the Tg of polyvinyl acetate can be reduced, resulting in improved plasticity of the composition.

In the composition of the present disclosure, the binder resin is preferably contained in an emulsified state.

In this case, the inorganic powder does not concentrate locally and is easily dispersed in the composition of the present disclosure.

### Plasticizer

In the composition of the present disclosure, R¹ in the structure represented by general formula (1) may be a linear or branched C1-C12 hydrocarbon group. R¹ may include an unsaturated bond or may be composed only of saturated bonds, preferably composed only of saturated bonds.

When R¹ includes an unsaturated bond, the unsaturated bond restricts intramolecular rotation, resulting in a rigid planar structure in the region where the unsaturated bond is present. When R¹ is composed only of saturated bonds, the intramolecular rotation is not restricted, and the composition tends to have high plasticity. R¹ is more preferably an n-butyl group.

In the composition of the present disclosure, R² in the structure represented by general formula (1) may be a linear, branched, or cyclic C1-C12 hydrocarbon group. R² may include an unsaturated bond or may be composed only of saturated bonds. R² is preferably a C3 linear hydrocarbon group.

In the composition of the present disclosure, R³ in the structure represented by general formula (1) is preferably a structure containing an oxygen atom, more preferably a C2-C12 ester group. R³ may include an unsaturated bond or may be composed only of saturated bonds.

In the composition of the present disclosure, X in the structure represented by general formula (1) is preferably a single bond.

In the composition of the present disclosure, R⁴ in the structure represented by general formula (1) is preferably a C2-C12 acyl group. R⁴ may include an unsaturated bond or may be composed only of saturated bonds. The “—O—R⁴” in the structure represented by general formula (1) is preferably an acetyloxy group.

In the composition of the present disclosure, R⁵ in the structure represented by general formula (1) may be a linear or branched C1-C12 hydrocarbon group. R⁵ may include an unsaturated bond or may be composed only of saturated bonds, preferably composed only of saturated bonds. R⁵ is preferably an n-butyl group.

In the composition of the present disclosure, the compound having the structure represented by general formula (1) may contain a derivative of at least one polyhydroxy acid selected from the group consisting of citric acid, malic acid, isocitric acid, tartaric acid, and tartronic acid.

Examples of the derivative of such a polyhydroxy acid include hydroxy acid alkyl esters, such as alkyl citrates, alkyl isocitrates, alkyl malates, alkyl tartrates, alkyl tartronates, alkyl acetyl citrates, alkyl acetyl isocitrates, alkyl acetyl malates, alkyl acetyl tartrates, and alkyl acetyl tartronates. In this case, the structure represented by general formula (1) may have a carboxyl group residue (i.e., R⁵ is a hydrogen atom) or a hydroxy group residue (i.e., R⁴ is a hydrogen atom).

In the composition of the present disclosure, the compound having the structure represented by general formula (1) is preferably acetyl tributyl citrate (ATBC), which is represented by general formula (2) below:.

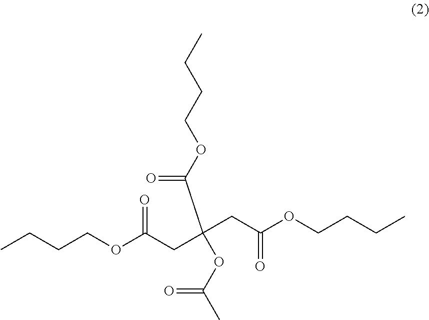

The above hydroxy acid alkyl esters are inexpensive and can reduce the costs for manufacturing the composition of the present disclosure.

### Solvent

The composition of the present disclosure may further contain a solvent.

Examples of the solvent include diethylene glycol monobutyl ether, diethylene glycol monobutyl ether acetate, texanol, eugenol, terpineol, dihydroterpineol, benzyl alcohol, ethanol, isophorone, methyl ethyl ketone, and diethyl ketone. These solvents are useful in uniformly mixing the inorganic powder, the binder resin, and the plasticizer in the composition of the present disclosure.

In the composition of the present disclosure, the percentage of the solvent is preferably 0.05 wt % or more and 20 wt % or less (i.e., from 0.05 wt % to 20 wt %).

### Other Additives

The composition of the present disclosure may further contain a dispersant, a defoamer, and a wetting agent as other additives.

Examples of the dispersant include ammonium polycarboxylate and maleic anhydride-styrene copolymer.

Examples of the defoamer include polyalkylene glycol, dimethylpolysiloxane, and octadecanol.

Examples of the wetting agent include polyalkylene glycol and polyglycerol.

### Proportion of Each Component and Like

The composition of the present disclosure preferably satisfies the following relationships where the amount of the inorganic powder is denoted by Vf by volume at room temperature and standard atmospheric pressure, the amount of the binder resin is denoted by Mb by weight, and the volume of the binder resin at room temperature and standard atmospheric pressure is denoted by Vb, the amount of the plasticizer is denoted by Mp by weight, and the volume of the plasticizer at room temperature and standard atmospheric pressure is denoted by Vp, and the amount of an additional organic substance is denoted by Vx by volume at room temperature and standard atmospheric pressure.

The “additional organic substance” means an organic substance other than the binder resin and the plasticizer, and includes organic substances exemplified as the solvent and other additives described above.

In the composition of the present disclosure, Vf/(Vf+Vb+Vp+Vx)×100 is preferably 45 vol % or more and 75 vol % or less (i.e., from 45 vol % to 75 vol %), more preferably 55 vol % or more and 70 vol % or less (i.e., from 55 vol % to 70 vol %).

If Vf/(Vf+Vb+Vp+Vx)×100 exceeds 75 vol %, the amount of the binder resin is so small that it is difficult for the inorganic powder particles to bond sufficiently with each other. As a result, when the composition is formed into a predetermined shape, the formed product tends to break.

If Vf/(Vf+Vb+Vp+Vx)×100 is less than 45 vol %, large dimensional changes during firing result in an increase in shrinkage-induced stress, which in turn increases the likelihood of crack formation.

Mb/Mp is preferably 1.5 or more and 50 or less (i.e., from 1.5 to 50), more preferably 2.5 or more and 40 or less (i.e., from 2.5 to 40).

If Mb/Mp exceeds 50 or more, it is difficult for the Tg of the binder resin to decrease sufficiently.

If Mb/Mp is less than 1.5, the Tg of the binder resin decreases excessively, and it is thus difficult to form the composition into a desired shape.

In the composition of the present disclosure, Vf/(Vf+Vb+Vp+Vx)×100 is preferably 45 vol % or more and 75 vol % or less (i.e., from 45 vol % to 75 vol %), and Mb/Mp is preferably 1.5 or more and 50 or less (i.e., from 1.5 to 50), and Vf/(Vf+Vb+Vp+Vx)×100 is more preferably 55 vol % or more and 70 vol % or less (i.e., from 55 vol % to 70 vol %), and Mb/Mp is more preferably 2.5 or more and 40 or less (i.e., from 2.5 to 40).

When the composition of the present disclosure contains the inorganic powder, the binder resin, and the plasticizer at such proportions, the binder resin and the plasticizer are unlikely to separate from each other and become uniform. Therefore, forming the composition of the present disclosure into a sheet shape and subsequently stacking the resulting sheet-like products leads to improved adhesion strength.

Next, a method for manufacturing the composition of the present disclosure will be described.

The method for manufacturing the composition of the present disclosure includes a grinding step of grinding an inorganic material into an inorganic powder and a mixing step of mixing the inorganic powder, a binder resin, and a plasticizer, wherein the plasticizer contains a compound having a structure represented by general formula (1) below.

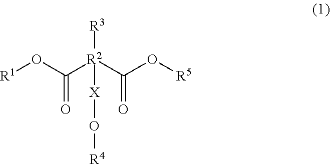

(In general formula (1), R¹ is a C1-C12 hydrocarbon group.

In general formula (1), R² is a C1-C12 hydrocarbon group.

In general formula (1), R³ is a hydrogen atom, a hydroxy group, a carboxy group, a C2-C12 ester group, a C2-C12 acyl group, a C2-C12 acyloxy group, or a C1-C12 alkoxy group.

In general formula (1), X is a single bond or a C1-C12 hydrocarbon group.

In general formula (1), R⁴ is a hydrogen atom, a C2-C12 acyl group, or a C1-C12 hydrocarbon group.

In general formula (1), R⁵ is a hydrogen atom or a C1-C12 hydrocarbon group).

The compound having the structure represented by general formula (1) above is not a phthalate ester. The method for manufacturing the composition of the present disclosure thus has a low environmental impact.

The use of the plasticizer containing the compound having the structure represented by general formula (1) above can sufficiently improve the plasticity of the manufactured composition.

In the method for manufacturing the composition of the present disclosure, additional organic substances such as solvents and additives may be added in the mixing step, and the inorganic powder, the binder resin, and the plasticizer are preferably mixed such that Vf/(Vf+Vb+Vp+Vx)×100 is 45 vol % or more and 75 vol % or less (i.e., from 45 vol % to 75 vol %), and Mb/Mp is 1.5 or more and 50 or less (i.e., from 1.5 to 50). In the mixing step, the inorganic powder, the binder resin, and the plasticizer are more preferably mixed such that Vf/(Vf+Vb+Vp+Vx)×100 is 55 vol % or more and 70 vol % or less (i.e., from 55 vol % to 70 vol %), and Mb/Mp is 2.5 or more and 40 or less (i.e., from 2.5 to 40).

When the manufactured composition contains the inorganic powder, the binder resin, and the plasticizer at such proportions, the binder resin and the plasticizer are unlikely to separate from each other and become uniform. Therefore, forming the manufactured composition into a sheet shape and subsequently stacking the resulting sheet-like products leads to improved adhesion strength.

Next, the chip-type multilayer electronic component produced by using the composition of the present disclosure will be described. The chip-type multilayer electronic component produced by using the composition of the present disclosure is also included in an aspect of the present disclosure.

The sheet-like products made of the composition of the present disclosure and the multilayer body including the sheet-like products stacked on top of one another are also produced in the production of the chip-type multilayer electronic component, and these sheet-like products and multilayer body are also included in aspects of the present disclosure.

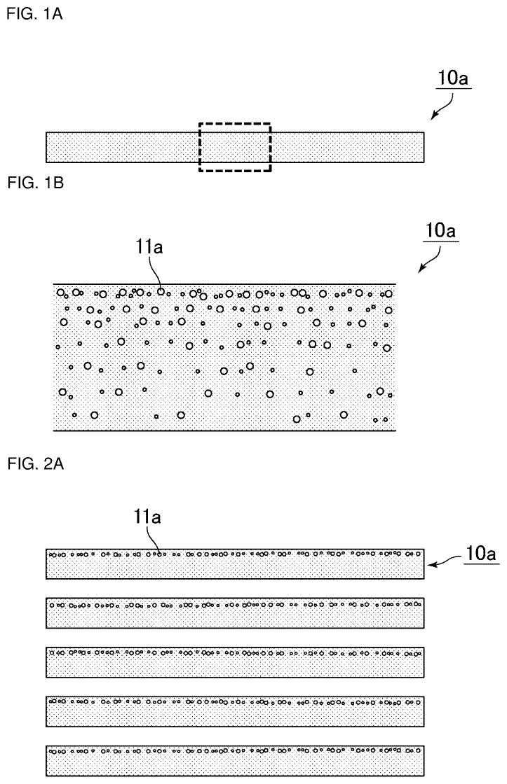

FIG. 1A is a schematic cross-sectional view of an example of a sheet-like product of the present disclosure.

FIG. 1B is an enlarged view of the area enclosed by the dashed line in FIG. 1A.

As illustrated in FIG. 1A, the composition of the present disclosure is first formed into a sheet shape to obtain a sheet-like product 10a in the production of the chip-type multilayer electronic component of the present disclosure.

The method for forming the composition of the present disclosure into a sheet shape is not limited, and a conventionally known method such as using a bar coater or printing can be employed.

As illustrated in FIG. 1B, the density of the binder resin 11a increases toward the top surface of the sheet-like product 10a in the production of the sheet-like product 10a since the binder resin has a lower specific gravity than the inorganic powder.

After forming the sheet-like product 10a, vias (not shown) may be formed in the sheet-like product 10a as necessary, and a conductive paste (not shown) may be applied to the sheet-like product 10a.

The vias and conductive paste can be formed by using conventionally known materials, and conventionally known methods can also be employed for their formation and application.

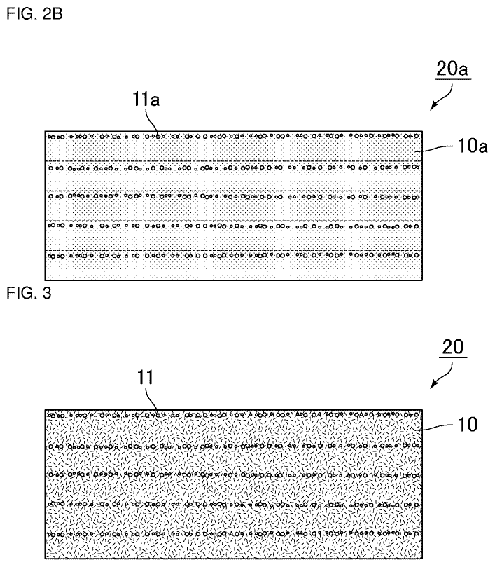

FIGS. 2A and 2B are schematic views of examples of the process for producing the multilayer body using the sheet-like product of the present disclosure.

Next, as illustrated FIG. 2A, a plurality of sheet-like products 10a are prepared.

As illustrated in FIG. 2B, the sheet-like products 10a are stacked on top of each other and pressure-bonded together to produce a mother block 20a, which is a multilayer body.

The pressure bonding conditions are not limited, and a conventionally known method can be employed.

The mother block 20a may then be cut into a predetermined shape to form a chip-like product.

The edges of the chip-like product may be further R-chamfered as necessary.

The mother block 20a and the chip-like product both correspond to the multilayer body of the present disclosure.

Next, the chip-like product is dewaxed and fired. The sheet-like products 10a accordingly become fired sheets 10, and a base body 20 including a plurality of fired sheets 10 stacked on top of one another as illustrated in FIG. 3 can be produced.

FIG. 3 is a schematic side view of an example of the base body including a plurality of fired sheets stacked on top of one another.

The conductive paste formed on the sheet-like products 10a becomes internal electrodes during this firing.

During the firing, the binder resin 11a contained in the sheet-like products 10a is thermally decomposed to form pores 11.

As described above, the density of the binder resin 11a increases toward the top surface in the sheet-like products 10a. Therefore, the areas with a high density of the binder resin 11a will also have a high density of the pores 11. Therefore, as illustrated in FIG. 3, the pores 11 appear to be linearly formed in the direction perpendicular to the stacking direction when the base body 20 is viewed from the side surface.

As illustrated in FIG. 3, the base body 20 is composed of a plurality of fired sheets 10 stacked on top of one another, and the base body 20 thus has the striped pattern perpendicular to the stacking direction when viewed from the side surface.

The base body 20 may have, for example, an outer electrode as necessary.

The chip-type multilayer electronic component of the present disclosure can be produced by using this method.

Since the base body 20 has the striped pattern perpendicular to the stacking direction when viewed from the side surface as described above, the side surfaces of the chip-type multilayer electronic component of the present disclosure including the base body 20 can be recognized by using this striped pattern as a marking.

In other words, when observing the chip-type multilayer electronic component, an observer can recognize the surfaces with the striped pattern as the side surfaces and the surfaces without the striped pattern as the top surface or the bottom surface in the base body of the chip-type multilayer electronic component.

It is not necessary to form other identification markings on the side surfaces, top surface, and bottom surface of the base body in the chip-type multilayer electronic component of the present disclosure. The production costs can thus be reduced.

The following disclosures are described in this specification.

The disclosure (1) is a composition comprising an inorganic powder, a binder resin, and a plasticizer, wherein the plasticizer contains a compound having a structure represented by general formula (1) below:

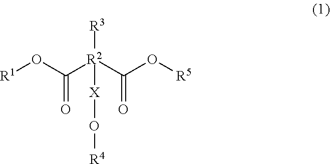

(In general formula (1), R¹ is a C1-C12 hydrocarbon group.

In general formula (1), R² is a C1-C12 hydrocarbon group.

In general formula (1), R³ is a hydrogen atom, a hydroxy group, a carboxy group, a C2-C12 ester group, a C2-C12 acyl group, a C2-C12 acyloxy group, or a C1-C12 alkoxy group.

In general formula (1), X is a single bond or a C1-C12 hydrocarbon group.

In general formula (1), R⁴ is a hydrogen atom, a C2-C12 acyl group, or a C1-C12 hydrocarbon group.

In general formula (1), R⁵ is a hydrogen atom or a C1-C12 hydrocarbon group).

The disclosure (2) is the composition according to the disclosure (1), wherein the plasticizer contains a derivative of at least one polyhydroxy acid selected from the group consisting of citric acid, malic acid, isocitric acid, tartaric acid, and tartronic acid.

The disclosure (3) is the composition according to the disclosure (1) or (2), further comprising a solvent.

The disclosure (4) is the composition according to any one of the disclosures (1) to (3), wherein the binder resin contains at least one selected from the group consisting of polyvinyl acetate, polyvinyl butyral, polyvinyl alcohol, acrylic, urethane, polyvinyl pyrrolidone, polyethylene glycol, ethylene-vinyl acetate copolymer, and cellulose ether.

The disclosure (5) is the composition according to any one of the disclosures (1) to (4), wherein the inorganic powder contains a ceramic powder.

The disclosure (6) is the composition according to any one of the disclosures (1) to (4), wherein the inorganic powder contains at least one selected from the group consisting of zirconia, titania, alumina, barium titanate, ferrite, PZT, zinc oxide, glass, and glass ceramics.

The disclosure (7) is the composition according to any one of the disclosures (1) to (6), further comprising an additional organic substance other than the binder resin and the plasticizer, wherein Vf/(Vf+Vb+Vp+Vx)×100 is 45 vol % or more and 75 vol % or less (i.e., from 45 vol % to 75 vol %), and Mb/Mp is 1.5 or more and 50 or less (i.e., from 1.5 to 50) when an amount of the inorganic powder is denoted by Vf by volume at room temperature (25° C.) and standard atmospheric pressure, an amount of the binder resin is denoted by Mb by weight, and a volume of the binder resin at room temperature and standard atmospheric pressure is denoted by Vb, an amount of the plasticizer is denoted by Mp by weight, and a volume of the plasticizer at room temperature and standard atmospheric pressure is denoted by Vp, and an amount of the additional organic substance is denoted by Vx by volume at room temperature and standard atmospheric pressure.

The disclosure (8) is a sheet-like product comprising the composition according to any one of the disclosures (1) to (7).

The disclosure (9) is a multilayer body comprising a plurality of the sheet-like products according to the disclosure (8) stacked on top of one another.

The disclosure (10) is a method for manufacturing a composition, the method comprising a grinding step of grinding an inorganic material into an inorganic powder and a mixing step of mixing the inorganic powder, a binder resin, and a plasticizer, wherein the plasticizer contains a compound having a structure represented by general formula (1) below:

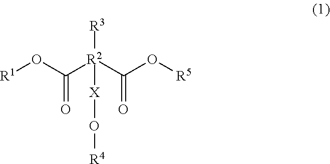

(In general formula (1), R¹ is a C1-C12 hydrocarbon group.

In general formula (1), R² is a C1-C12 hydrocarbon group.

In general formula (1), R³ is a hydrogen atom, a hydroxy group, a carboxy group, a C2-C12 ester group, a C2-C12 acyl group, a C2-C12 acyloxy group, or a C1-C12 alkoxy group.

In general formula (1), X is a single bond or a C1-C12 hydrocarbon group.

In general formula (1), R⁴ is a hydrogen atom, a C2-C12 acyl group, or a C1-C12 hydrocarbon group.

In general formula (1), R⁵ is a hydrogen atom or a C1-C12 hydrocarbon group).

The disclosure (11) is the method for manufacturing a composition according to the disclosure (10), wherein the mixing step involves mixing an additional organic substance other than the binder resin and the plasticizer and further mixing the inorganic powder, the binder resin, the plasticizer, and the additional organic substance such that Vf/(Vf+Vb+Vp+Vx)×100 is 45 vol % or more and 75 vol % or less (i.e., from 45 vol % to 75 vol %), and Mb/Mp is 1.5 or more and 50 or less (i.e., from 1.5 to 50) when an amount of the inorganic powder is denoted by Vf by volume at room temperature (25° C.) and standard atmospheric pressure, an amount of the binder resin is denoted by Mb by weight, and a volume of the binder resin at room temperature and standard atmospheric pressure is denoted by Vb, an amount of the plasticizer is denoted by Mp by weight, and a volume of the plasticizer at room temperature and standard atmospheric pressure is denoted by Vp, and an amount of the additional organic substance is denoted by Vx by volume at room temperature and standard atmospheric pressure.

The disclosure (12) is a chip-type multilayer electronic component comprising a base body including a plurality of fired sheets stacked on top of one another, wherein the base body has a striped pattern perpendicular to a stacking direction when viewed from a side surface.

### Examples

Examples, which more specifically disclose the composition of the present disclosure and the like, will be described below. The present disclosure is not limited to the following Examples.

### Examples

A ferrite powder (inorganic powder) was produced by mixing 50 parts by weight of pure water relative to 100 parts by weight of ferrite, 0.5 parts by weight of ammonium polycarboxylate (dispersant) relative to 100 parts by weight of ferrite, and ferrite, and grinding the resulting mixture with a ball mill.

Next, the ferrite powder, polyvinyl acetate (binder resin), and acetyl tributyl citrate (plasticizer) were blended in a predetermined ratio (details are provided below) to produce a slurry-like composition according to Example.

Next, after defoaming the composition according to Example, the composition was applied in a sheet form to a PET film and dried with hot air to produce a sheet-like product (thickness: about 50 μm) according to Example.

### Comparative Examples

A ferrite powder was produced using the same method as in Example, and the ferrite powder, polyvinyl acetate (binder resin), and dibutyl phthalate (plasticizer) were blended in a predetermined ratio (details are provided below) to produce a slurry-like composition according to Comparative Example.

Next, after defoaming the composition according to Comparative Example, the composition was applied in a sheet form to a PET film and dried with hot air to produce a sheet-like product (thickness: about 50 μm) according to Comparative Example.

### Dynamic Viscoelasticity Measurement and Tg Calculation

A plurality of the sheet-like products according to each of Examples and Comparative Examples were prepared such that the ratio of polyvinyl acetate and plasticizer blended relative to the ferrite powder was as shown in Table 1.

Next, the sheet-like products according to each of Examples and Comparative Examples were pressure-bonded together to produce a multilayer body with a thickness of 500 μm.

Next, the multilayer body according to each of Examples and Comparative Examples was cut to width×length=10 mm×50 mm and used as a test sample.

Next, the dynamic viscoelasticity was measured using the test sample according to each of Examples and Comparative Examples.

The dynamic viscoelasticity was measured using a viscoelasticity analyzer (model: DMA7000, manufacturer: Hitachi High-Tech Corporation) in the measurement temperature range of −30° C. to 100° C.

Based on the results of the dynamic viscoelasticity measurement, the Tg of the binder resin contained in the composition according to each of Examples and Comparative Examples was calculated.

The results are shown in Table 1.

TABLE 1

| | | | | | | Comparative | | |
|---|---|---|---|---|---|---|---|---|
| | | Examples | | | | Examples | | |
| Compounds | binder resin | polyvinyl acetate | | | | polyvinyl acetate | | |
| | plasticizer | acetyl tributyl citrate | | | | dibutyl phthalate | | |
| Composition | Vf/(Vf + Vb + Vp + Vx) × 100 | 56 | 56 | 56 | 56 | 56 | 56 | 56 |
| | Mb/Mp | 3.0 | 8.3 | 16.8 | 33.3 | 8.3 | 16.8 | 33.3 |

| | | | | | | | |
|---|---|---|---|---|---|---|---|
| Glass transition temperature (° C.) | −2.4 | 18.3 | 26.1 | 29.7 | 16.6 | 26.0 | 30.1 |

In Table 1, Vf denotes the volume of the inorganic powder, Vb denotes the volume of the binder resin, Vp denotes the volume of the plasticizer, and Vx denotes the volume of the additional organic substance.

In Table 1, Mb denotes the weight of the binder resin, and Mp denotes the amount of the plasticizer.

As shown in Table 1, the Tg of polyvinyl acetate contained in the composition was found to decrease to the same extent when acetyl tributyl citrate was used as a plasticizer as when dibutyl phthalate was used as a plasticizer.

### Measurement of Adhesion Strength

A sheet-like product according to Example in which Vf/(Vf+Vb+Vp+Vx)×100 was 59 vol % and Mb/Mp was 16.8 was prepared.

The adhesion strength of the sheet-like product according to Example was measured using the TAC test.

The TAC test was performed using a tacking tester (model name: TAC1000, manufacturer: Rhesca Co., Ltd.) at a measurement temperature of 55° C.

The adhesion strength of the sheet-like product according to Example was 169 gf.

Next, sheet-like products according to Examples in which the weight ratios (wt %) of polyvinyl acetate and acetyl tributyl citrate relative to the ferrite powder were as shown in Table 2 were prepared. The adhesion strength of the sheet-like product according to each Example was measured using the same method as above and evaluated.

The evaluation criteria are as described below. The results are shown in Table 2.
A: The adhesion strength of the sheet-like product is 100 gf or more.
B: The adhesion strength of the sheet-like product is 30 gf or more and less than 100 gf (i.e., from 30 gf to 100 gf).
C: The adhesion strength of the sheet-like product is less than 30 gf.

TABLE 2

| | | Vf/(Vf + Vb + Vp + Vx) × 100 (Volume | | | | | | | | |
|---|---|---|---|---|---|---|---|---|---|---|
| | | percentage of inorganic powder in composition) | | | | | | | | |
| | | 80 | 75 | 70 | 65 | 60 | 55 | 50 | 45 | 40 |
| Mb/Mp | 100 | C | C | C | C | C | C | C | C | C |
| (Weight | 50 | C | B | B | B | B | B | B | B | B |
| ratio | 40 | C | B | A | A | A | A | A | A | A |
| of | 33.3 | C | B | A | A | A | A | A | A | A |
| binder | 16.8 | C | B | A | A | A | A | A | A | A |
| resin | 8.3 | C | B | A | A | A | A | A | A | A |
| to | 3.3 | C | B | A | A | A | A | A | A | A |
| plasticizer) | 3 | C | B | A | A | A | A | A | A | A |
| | 2.5 | C | B | A | A | A | A | A | A | A |
| | 2 | C | B | B | B | B | B | B | B | B |
| | 1.5 | C | B | B | B | B | B | B | B | B |
| | 1 | C | C | C | C | C | C | C | C | C |

The sheet-like products according to Examples rated as “A” in the evaluation of the adhesion strength have high adhesion strength possibly because polyvinyl acetate and acetyl tributyl citrate are unlikely to separate from each other.

The sheet-like products according to Examples rated as “B” in the evaluation of the adhesion strength have moderate adhesion strength possibly because polyvinyl acetate and acetyl tributyl citrate slightly easily separate from each other or the glass transition temperature is slightly high.

The sheet-like products according to Examples rated as “C” in the evaluation of the adhesion strength does not have sufficiently high adhesion strength possibly because polyvinyl acetate and acetyl tributyl citrate tend to separate from each other or the glass transition temperature is high.

The compositions according to Examples can be said to have a low environmental impact because the compositions according to Examples are free of phthalate esters.

From the above results, the compositions according to Examples are found to have plasticity suitable for forming a sheet-like product.

The formed sheet-like product is also found to have sufficient adhesion strength.

### Calculation of Firing Shrinkage Rate

A plurality of the sheet-like products according to each Example were prepared such that the ratio of polyvinyl acetate and plasticizer blended relative to the ferrite powder was as shown in Table 3 and Table 4.

Next, the sheet-like products according to each Example were pressure-bonded together to produce a multilayer body with a thickness of about 1 mm.

Next, the multilayer body according to each Example was cut to width×length=10 mm×50 mm and used as a test sample.

Next, after measuring the thickness and width of the test sample according to each Example, the test sample was then dewaxed and fired, and the shrinkage rate was calculated from the dimensions before and after firing.

The results are shown in Table 3 and Table 4.

The evaluation criteria in Table 4 are as described below.
A: The shrinkage rate of the multilayer body due to firing is 19% or less.
B: The shrinkage rate of the multilayer body due to firing is more than 19% and 22% or less (i.e., from 19% to 22%).
C: The shrinkage rate of the multilayer body due to firing is more than 22%.

TABLE 3

| | | Examples | | | |
|---|---|---|---|---|---|
| Compounds | binder resin | polyvinyl acetate | | | |
| | plasticizer | acetyl tributyl citrate | | | |
| Composition | Vf/(Vf + Vb + | 51 | 55 | 59 | 63 |
| | Vp + Vx) × 100 | | | | |
| | Mb/Mp | 16.8 | 16.8 | 16.8 | 16.8 |

| | | | | |
|---|---|---|---|---|
| Firing shrinkage rate (%) | −19.4 | −18.0 | −17.8 | −17.7 |

TABLE 4

| | | Vf/(Vf + Vb + Vp + Vx) × 100 (Volume | | | | | | | | |
|---|---|---|---|---|---|---|---|---|---|---|
| | | percentage of inorganic powder in composition) | | | | | | | | |
| | | 80 | 75 | 70 | 65 | 60 | 55 | 50 | 45 | 40 |
| Mb/Mp | 100 | A | A | A | A | A | A | B | B | C |
| (Weight | 50 | A | A | A | A | A | A | B | B | C |
| | 40 | A | A | A | A | A | A | B | B | C |
| | 33.3 | A | A | A | A | A | A | B | B | C |
| | 16.8 | A | A | A | A | A | A | B | B | C |
| | 8.3 | A | A | A | A | A | A | B | B | C |
| | 3.3 | A | A | A | A | A | A | B | B | C |
| | 3 | A | A | A | A | A | A | B | B | C |
| | 2.5 | A | A | A | A | A | A | B | B | C |
| | 2 | A | A | A | A | A | A | B | B | C |
| | 1.5 | A | A | A | A | A | A | B | B | C |
| | 1 | A | A | A | A | A | A | B | B | C |

The multilayer bodies according to Examples rated as “A” in the evaluation of the adhesion strength exhibit an almost constant shrinkage rate possibly due to the constant packing rate of the inorganic powder.

The multilayer bodies according to Examples rated as “B” in the evaluation of the adhesion strength exhibit slightly large shrinkage rate possibly because the packing rate of the inorganic powder is slightly low.

The multilayer bodies according to Examples rated as “C” in the evaluation of the adhesion strength exhibit large shrinkage rate possibly because the packing rate of the inorganic powder is low.

In the evaluation, Examples that satisfy both the rating A in Table 2 and the rating A in Table 4 exhibit high adhesion strength and are less likely to undergo structural defects and can thus be rated as “Excellent.” Examples that are rated as “B” in at least one of the ratings in Table 2 and Table 4 can be rated as “Available.” Other Examples can be rated as “Good.” This evaluation is shown in Table 5.

TABLE 5

| | | Vf/(Vf + Vb + Vp + Vx) × 100 (Volume percentage of inorganic powder in composition) | | | | | | | | |
|---|---|---|---|---|---|---|---|---|---|---|
| | | 80 | 75 | 70 | 65 | 60 | 55 | 50 | 45 | 40 |
| Mb/Mp | 100 | Available | Available | Available | Available | Available | Available | Available | Available | Available |
| (Weight | 50 | Available | Good | Good | Good | Good | Good | Good | Good | Available |
| ratio | 40 | Available | Good | Excellent | Excellent | Excellent | Excellent | Good | Good | Available |
| of | 33.3 | Available | Good | Excellent | Excellent | Excellent | Excellent | Good | Good | Available |
| binder | 16.8 | Available | Good | Excellent | Excellent | Excellent | Excellent | Good | Good | Available |
| resin | 8.3 | Available | Good | Excellent | Excellent | Excellent | Excellent | Good | Good | Available |
| to | 3.3 | Available | Good | Excellent | Excellent | Excellent | Excellent | Good | Good | Available |
| plasticizer) | 3 | Available | Good | Excellent | Excellent | Excellent | Excellent | Good | Good | Available |
| | 2.5 | Available | Good | Excellent | Excellent | Excellent | Excellent | Good | Good | Available |
| | 2 | Available | Good | Good | Good | Good | Good | Good | Good | Available |
| | 1.5 | Available | Good | Good | Good | Good | Good | Good | Good | Available |
| | 1 | Available | Available | Available | Available | Available | Available | Available | Available | Available |

What is claimed is:

1. A composition comprising:
an inorganic powder;
a binder resin; and
a plasticizer,
wherein the plasticizer includes a compound having a structure represented by general formula (1) below: 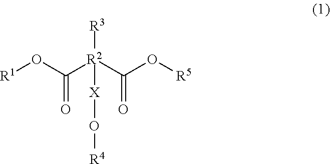
in general formula (1), R¹ is a C1-C12 hydrocarbon group,
in general formula (1), R² is a C1-C12 hydrocarbon group,
in general formula (1), R³ is a hydrogen atom, a hydroxy group, a carboxy group, a C2-C12 ester group, a C2-C12 acyl group, a C2-C12 acyloxy group, or a C1-C12 alkoxy group,
in general formula (1), X is a single bond or a C1-C12 hydrocarbon group,
in general formula (1), R⁴ is a hydrogen atom, a C2-C12 acyl group, or a C1-C12 hydrocarbon group, and
in general formula (1), R⁵ is a hydrogen atom or a C1-C12 hydrocarbon group.

2. The composition according to claim 1, wherein
the plasticizer includes a derivative of at least one polyhydroxy acid selected from the group consisting of citric acid, malic acid, isocitric acid, tartaric acid, and tartronic acid.

3. The composition according to claim 1, further comprising:
a solvent.

4. The composition according to claim 1, wherein
the binder resin includes at least one selected from the group consisting of polyvinyl acetate, polyvinyl butyral, polyvinyl alcohol, acrylic, urethane, polyvinyl pyrrolidone, polyethylene glycol, ethylene-vinyl acetate copolymer, and cellulose ether.

5. The composition according to claim 1, wherein
the inorganic powder includes a ceramic powder.

6. The composition according to claim 1, wherein
the inorganic powder includes at least one selected from the group consisting of zirconia, titania, alumina, barium titanate, ferrite, lead zirconate titanate (PZT), zinc oxide, glass, and glass ceramics.

7. The composition according to claim 1, further comprising:
an additional organic substance other than the binder resin and the plasticizer, wherein Vf/(Vf+Vb+Vp+Vx)×100 is from 45 vol % to 75 vol %, and Mb/Mp is from 1.5 to 50,
when an amount of the inorganic powder is denoted by Vf by volume at room temperature (25° C.) and standard atmospheric pressure,
an amount of the binder resin is denoted by Mb by weight, and is denoted by Vb by volume of the binder resin at room temperature and standard atmospheric pressure,
an amount of the plasticizer is denoted by Mp by weight, and is denoted by Vp by volume of the plasticizer at room temperature and standard atmospheric pressure, and
an amount of the additional organic substance is denoted by Vx by volume at room temperature and standard atmospheric pressure.

8. A sheet-like product comprising:
the composition according to claim 1.

9. A multilayer body comprising:
a plurality of the sheet-like products according to claim 8 stacked on top of one another.

10. A sheet-like product comprising:
the composition according to claim 2.

11. A sheet-like product comprising:
the composition according to claim 3.

12. A sheet-like product comprising:
the composition according to claim 4.

13. A sheet-like product comprising:
the composition according to claim 5.

14. A sheet-like product comprising:
the composition according to claim 6.

15. A sheet-like product comprising:
the composition according to claim 7.

16. A multilayer body comprising:
a plurality of the sheet-like products according to claim 10 stacked on top of one another.

17. A multilayer body comprising:
a plurality of the sheet-like products according to claim 11 stacked on top of one another.

18. A method for manufacturing a composition, the method comprising:
grinding an inorganic material into an inorganic powder; and
mixing the inorganic powder, a binder resin, and a plasticizer,
wherein the plasticizer includes a compound having a structure represented by general formula (1) below: 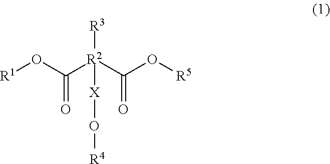
in general formula (1), R¹ is a C1-C12 hydrocarbon group,
in general formula (1), R² is a C1-C12 hydrocarbon group,
in general formula (1), R³ is a hydrogen atom, a hydroxy group, a carboxy group, a C2-C12 ester group, a C2-C12 acyl group, a C2-C12 acyloxy group, or a C1-C12 alkoxy group,
in general formula (1), X is a single bond or a C1-C12 hydrocarbon group,
in general formula (1), R⁴ is a hydrogen atom, a C2-C12 acyl group, or a C1-C12 hydrocarbon group,
in general formula (1), R⁵ is a hydrogen atom or a C1-C12 hydrocarbon group.

19. The method for manufacturing a composition according to claim 18, wherein
the mixing includes
mixing an additional organic substance other than the binder resin and the plasticizer, and
further mixing the inorganic powder, the binder resin, the plasticizer, and the additional organic substance such that
Vf/(Vf+Vb+Vp+Vx)×100 is from 45 vol % to 75 vol %, and Mb/Mp is from 1.5 to 50
when an amount of the inorganic powder is denoted by Vf by volume at room temperature (25° C.) and standard atmospheric pressure,
an amount of the binder resin is denoted by Mb by weight, and is denoted by Vb by volume of the binder resin at room temperature and standard atmospheric pressure,
an amount of the plasticizer is denoted by Mp by weight, and is denoted by Vp by volume of the plasticizer at room temperature and standard atmospheric pressure, and
an amount of the additional organic substance is denoted by Vx by volume at room temperature and standard atmospheric pressure.

20. A chip-type multilayer electronic component comprising:
a base body including a plurality of sheets stacked on top of one another and fired,
wherein the base body has a striped pattern perpendicular to a stacking direction when viewed from a side surface of the base body.
